(19) United States
(12) Patent Application Publication
(10) Pub. No.: US 2010/0239629 A1
(43) Pub. Date: Sep. 23, 2010

(54) Delivery system for delivering bioactive materials

(75) Inventors: Kolazi S. Narayanan, Wayne, NJ (US); Domingo Jon, New York, NY (US); Jayanti Patel, Elmwood Park, NJ (US); Karen Winkowski, Springfield, NJ (US)

Correspondence Address: INTERNATIONAL SPECIALTY PRODUCTS;Attn: William J. Davis, Esq., Legal Dept., Bldg. 8-2, 1361 Alps Road, Wayne, NJ, 07470, US

(73) Assignee: ISP INVESTMENTS INC.

(21) Appl. No.: 11/496,599

(22) Filed: Jul. 31, 2006

(51) Int. Cl. A01N 25/34; A01N 25/00; A01N 31/14

(52) U.S. Cl. 424/408; 424/405; 514/721

(57) ABSTRACT

A delivery system for delivering bioactive materials as an aqueous nanoparticle dispersion of a water soluble matrix of polyvinylpyrrolidone (PVP) polymer and copolymers thereof, and an anionic surfactant.

### BACKGROUND OF THE INVENTION

1. Field of the Invention

This invention relates to a system for delivering bioactive materials, and, more particularly, to a water soluble matrix of polyvinylpyrrolidone (PVP) and copolymers thereof, and an anionic surfactant, in the form of a complex, for solubilizing the bioactive material, as a nanoparticle dispersion, at reduced levels of surfactant.

2. Description of the Prior Art

D. Childers et al, in U.S. Pat. No. 6,413,921, described an antimicrobial composition containing parachlorometaxylenol (PCMX) as antimicrobial in an anionic surfactant composition comprising a mixture of surfactants including a surfactant having a hydrophobic portion, a sarcosine surfactant, and a foaming anionic surfactant such as sodium lauryl sulfate. The antimicrobial composition was used for disinfection of a skin surface in preparation for surgery.

### SUMMARY OF THE INVENTION

What is described herein is a delivery system for bioactive materials which includes a water soluble matrix of polyvinyl pyrrolidone (PVP) polymer, or copolymers thereof, and an anionic surfactant, in the form of a complex. The delivery system of the invention is a water soluble nanoparticulate dispersion/microemulsion of the bioactive material in the defined matrix. A typical delivery system includes triclosan as antibacterial in a mouthwash formulation, a toothpaste, a shampoo, or in a drug tablet.

A use composition of the invention is for water purification, cleaning composition or for wound dressing.

A typical formulation comprises, by weight, a water clear composition of 3% triclosan, 3% PVP K-30 and 10.5% sodium dodecylsulfate (SDS). A feature of this invention is that the polymer and surfactant forms a complex which can solubilize the bioactive material in water even below the critical micellular concentration (cmc) of the surfactant itself.

### DETAILED DESCRIPTION OF THE INVENTION

Suitable bioactive materials include triclosan, chlorhexidine, iodopropargyl butyl carbamate (IPBC), orthophenyl phenol, parachlorometaxylenol (PCMX), parachloro ortho benzyl phenol, tertiary amyl phenol, pine oil, mixed phenol disinfectants, mixed phenol and quats.

Suitable water soluble polymers for forming the polymer-surfactant complex in the matrix of the invention includes PVP, alkylated PVP copolymers, PVA-vinyl acetate copolymers, and the like.

Suitable anionic sulfactants include sulfonic acid derivatives, such as sodium dodecyl sulfate, laureth sulfate, alkyl sulfonate, sarcosinate, alkyl phosphate ester, and the like.

The presence of the water soluble PVP polymer in the matrix is essential for forming a polymer-surfactant complex which can dissolve the bioactive material even with low amounts of surfactant present in the composition. Both the use of a low level of anionic surfactant and the complexing polymer like PVP provides a substantially irritant-free composition.

The amount of SDS to solubilize the active in water depends on the active to be solubilized and concentration of the active ingredient. The higher the active ingredient concentration, the higher the amount of SDS to be added.

For compositions of the polymer-surfactant-complex and hydrophobic bioactive materials the weight ratio of bioactive material to polymer suitably is 1:5 to 5:0.5, preferably 1:0.2 to 1:2. The weight ratio of bioactive material to surfactant suitably is 1:10 to 2:1, preferably 1:3 to 1:5. The use level of bioactive suitably is 10 ppm to 10%, preferably 100 ppm to 5%, and most preferably 0.05% to 0.2%. The rest is water.

### Example 1

3% Triclosan was dissolved in water containing, by weight, 3% polyvinylpyrrolidone (PVP K-30) and 10% sodium dodecyl sulfate (SDS). The aqueous concentrate was diluted at 1/10, 1/30, 1/60, and 1/120 to produce optically clear, ready-to-use disinfectant compositions. Triclosan in these compositions were in the nano-particle range.

Compositions with lower than 10% SDS or with 10% SDS in the absence of PVP did not dissolve the triclosan.

### Example 2

A use formulation containing, by weight, 3% triclosan, 3% PVP K-30 and 10.5% SDS was diluted with water at a weight ratio of 1/450 to a final concentration of 66 ppm triclosan, 66 ppm PVP K-30 and 230 ppm SDS. The diluted sample remained clear without any precipitate. While the amount of SDS at this dilution is below the cmc of SDS itself, it was above the critical aggregation concentration of an insitu formed PVP-SDS complex. Thus, the disinfectant active triclosan ingredients were maintained soluble in water at this low surfactant content because it was present in the polymer-surfactant complex.

### Example 3

5.4% 2-phenylphenol was dissolved in water containing, by weight, 2.3% PVP K-30 and 16.6% SDS. The aqueous concentrate was diluted at 3.6/100 and 1.9/100 to produce optically clear, ready-to-use disinfectant compositions. 2-phenylphenol in these compositions was in the nanoparticle range.

### Example 4

4.2% Triclosan was dissolved in water containing, by weight, 3.2% PVP K-30 and 17% SDS. The aqueous concentrate was diluted at 4.6/100 and 2.3/100 to produce optically clear, ready-to-use disinfectant compositions. Triclosan in these compositions was in the nanoparticle range.

### Example 5

2% Triclosan was dissolved in water containing, by weight, 2% PVP K-30 and 7% SDS. The optically clear aqueous concentrate was diluted at 1/10 and 1/20 to produce optically clear, ready-to-use disinfectant compositions. Triclosan in these compositions was in the nanoparticle range.

### Example 6

2% Triclosan was added to water containing, by weight, 2% PVP K-30. Triclosan remained undissolved in the aqueous concentrate.

### Example 7

2% Triclosan was added to water containing, by weight, 7% SDS. The sample was heated to 60° C. for 3 days. Triclosan remained undissolved in the aqueous concentrate.

### Example 8

1% Ferulic acid was dissolved in water containing, by weight, 2.8% PVP K-30 and 6.3% SDS. The aqueous solution was optically clear and in the nanoparticle range.

### Example 9

5.4% PCMX was dissolved in water containing, by weight, 16.5% SDS and 2.3% PVP K-30. The aqueous concentrate was diluted at 1/10, 1/20, 1/40, 1/100, and 1/450 to produce optically clear, ready-to-use disinfectant compositions. PCMX in these compositions was found to be in nanoparticle range.

### Example 10

2% PCMX was dissolved in water containing, by weight, 6% SDS and 1% PVP K-30. The aqueous concentrate was diluted at 1/10, 1/20 to produce optically clear, ready-to-use disinfectant compositions. PCMX in these compositions was found to be in nanoparticle range.

### Biological Activity

The formulation described in Example 10 was diluted in DI water to contain 1000 ppm of PCMX. Antimicrobial activity was demonostrated against Pseudomonas aeruginosa (ATCC 10145) and Bacillus subtilis (ATCC 27328). One hundred microliters of an overnight culture of each bacterial cell suspension were inoculated into the diluted sample to a final concentration of about 10⁷ CFU/ml. The same bacterial suspension was also added to DI water to serve as a control. After 5 minutes incubation time at room temperature, the samples were serially diluted in Modified Letheen broth and plated onto modified Letheen Agar. Plates were incubated at 32° C. for 24 hours and bacterial growth enumerated. Log reduction was calculated based on the log difference in bacterial counts between the control sample (no PCMX) and PCMX containing sample. The results are presented in the following table.

TABLE

| | P. aeruginosa | Log | B. subtilis | Log |
|---|---|---|---|---|
| Treatment | CFU/ml | Reduction | CFU/ml | Reduction |
| DI water | 9.8 × 10⁷ | — | 4.0 × 10⁷ | — |
| 1000 ppm PCMX | <1 × 10² | 6 | 3.3 × 10³ | 4 |

### Example 11

2% PCMX was added to water containing, by weight, 2% PVP K-30. PCMX remained undissolved in the aqueous concentrate.

### Example 12

4.9% PCMX was dissolved in water containing, by weight, 13.8% SDS and 4% PVP K-30. This clear aqueous concentrate was diluted at 1/10, 1/20 to produce optically clear, ready-to-use disinfectant compositions at RT (18° C.). PCMX in these compositions was found to be in nanoparticle range.

### Example 13

4.9% PCMX was added to water containing, by weight, 14.4% SDS. The sample was heated and cooled to RT (18° C.). PCMX remained undissolved in the aqueous concentrate.

While the invention has been described with particular reference to certain embodiments thereof, it will be understood that changes and modifications may be made which are within the skill of the art.

1. A delivery system for delivering bioactive materials comprising an aqueous nanoparticle dispersion of bioactive material and a water soluble matrix of (a) polyvinylpyrrolidone polymer, or copolymers thereof, and (b) an anionic surfactant, wherein (a) and (b) form a complex which can solubilize the bioactive material in water below the critical micellular concentration of the surfactant.

2. (canceled)

3. A delivery system according to claim 1 wherein the weight ratio of bioactive material to (a) is 1:5 to 5:0.5.

4. A delivery system according to claim 3 wherein said ratio is 1:0.2 to 1:2.

5. A delivery system according to claim 1 wherein the weight ratio of bioactive material to (b) is 1:10 to 2:1.

6. A delivery system according to claim 5 wherein said ratio is 1:3 to 1:5.

7. A delivery system according to claim 1 wherein the weight ratio of (a):(b) is 10:1 to 1:10.

8. A delivery system according to claim 1 wherein said bioactive material is a disinfectant or mixture of disinfectants.

9. A delivery system according to claim 8 wherein said disinfectant is a phenolic compound.

10. A delivery system according to claim 8 wherein said disinfectant is selected from the group consisting of triclosan, chlorhexidine, iodopropargyl butyl carbamate (IPBC), orthophenyl phenol, parachlorometaxylenol (PCMX), parachloro ortho benzyl phenol, pine oil, mixed phenol disinfectants, mixed phenol and quats.

11. A delivery system according to claim 8 wherein said disinfectant is triclosan.

12. A composition comprising the delivery system of claim 1 and water of dilution.

13. A composition according to claim 12 wherein said bioactive material is present in an amount of 10 ppm to 10%.

14. A composition according to claim 12 wherein said bioactive material is present in an amount of 0.05 to 0.2%.

15. A composition according to claim 12 in which said bioactive mixture comprises triclosan.

16. (canceled)

17. A delivery system according to claim 1 comprising, by weight, 3% triclosan, 3% PVP K-30 and 10.5 sodium dodecyl sulfate.

18. A composition comprising the delivery system of claim 17 diluted with water at a ratio of 1/450 to a final concentration of 66 ppm triclosan, 66 ppm PVP K-30 and 230 ppm sodium dodecyl sulfate.

19. A composition according to claim 15 further including a bridging compound to bind proteinaceous material in the mouth for sustained release.

20. A composition according to claim 19 wherein said material is a tannin.

21. A tablet comprising the delivery system of claim 1.
